(19) United States
(12) Patent Application Publication
(10) Pub. No.: US 2024/0007136 A1
(43) Pub. Date: Jan. 4, 2024

(54) MONOLITHIC COMBINED TRANSCEIVER

(71) Applicant: ONiO AS, Oslo (NO)

(72) Inventor: Vemund BAKKEN, Oslo (NO)

(21) Appl. No.: 17/852,377

(22) Filed: Jun. 29, 2022

(51) Int. Cl. H04B 1/00; H04W 72/12

(52) U.S. Cl. CPC H04B 1/0067; H04W 72/1215

(57) ABSTRACT

A monolithic combined transceiver and a method for operating the monolithic combined transceiver, comprising narrowband and ultra wideband radio transceivers are provided.

The invention attains the above-described objective by a monolithic combined transceiver comprises, a narrowband transceiver, and an ultra wideband transceiver, wherein the monolithic combined transceiver is implemented on a continuous piece of a semiconductor, and a method to operate said monolithic combined transceiver.

### BACKGROUND OF THE INVENTION

### Field of the Invention

The invention relates to transceivers in general and more specifically a monolithic combined transceiver and a method for operating the monolithic combined transceiver, the combined transceiver comprising narrowband and ultra wideband radio transceivers.

### Background Art

State of the art is reflected in separate radio transceivers implemented in different pieces of silicon. Thus, a system with narrowband (NB) and ultra wideband (UWB) radio transceivers occupies a larger space on a printed circuit board, and has high packaging overhead and high external components counts. Such systems are generally expensive. Furthermore, a monolithic system allows for the narrowband and ultra wideband radio transceivers to share the same physical RF pins. They can also in some embodiments share a common antenna structure. In certain applications the two radio transceivers can work in conjunction with each other. In some embodiments it is beneficial to use the UWB radio system for accurate ranging for the purpose of spatial localization. Meanwhile the narrow band radio transceiver can be used as an interrogator asking what type of object is present and also to interchange important data such as time of flight information.

There is therefore a need for a method and a system to overcome the above-mentioned problems.

### SUMMARY OF THE INVENTION

### Problems to be Solved by the Invention

A main objective of the present invention is to provide a common radio transceiver for both narrow band and ultra wideband (Frequency) RF signals.

By collocating one or more narrow band radio transceivers with one or more ultra wideband radio transceivers on one monolithic piece of silicon it is possible for the radio transceivers to share common electrical subsystems such as; bias generators, voltage references, power supplies, crystal and clock reference, delay cells, RF pins, RF switches, digital baseband blocks etc. Following a traditional multichip approach these cells would be duplicated once per chip. The monolithic approach gives lower area overhead but also reduces energy consumption significantly.

When utilising one or more radio transceivers at the same time, even when the wavebands used are significantly different from each other (narrow band signal vs ultra wideband signal) it is critical to schedule when they send or receive transmissions in order to avoid collisions. This is critical when, for instance, tailing (sending immediately after) a narrow band radio transmission with ultra wideband transmission to allow for accurate spatial localization. The UWB signals can be used for very accurate measurement of time of flight (ToF) for an RF signal sent between a transmitting radio transceiver and a receiving radio transceiver. UWB signals are far superior for this purpose, as they are less prone to reflections compared with narrow band signals.

Antennas take up significant area on a printed circuit board or within an encapsulation. Combining antennas for both NB and UWB is thus a great improvement. This is possible with this invention where RF pins/pads can be shared between the NB and UWB domain resulting in a single pin (single ended RF) or two pins (differential RF) shared for the two signal domains.

### Means for Solving the Problems

The objective is achieved according to the invention by monolithic combined transceiver as defined in the preamble of claim 1, having the features of the characterising portion of claim 1, and a method for operating the monolithic combined transceiver as defined in the preamble of claim 15, having the features of the characterising portion of claim 15.

A number of non-exhaustive embodiments, variants or alternatives of the invention are defined by the dependent claims.

The present invention attains the above-described objective by a monolithic combined transceiver comprising a narrowband transceiver, and an ultra wideband transceiver, wherein the monolithic combined transceiver is implemented on a continuous piece of a semiconductor.

In a first aspect of the invention a monolithic combined transceiver is provided, wherein the monolithic combined transceiver comprises at least one narrowband transceiver and at least one ultra wideband transceiver, wherein the monolithic combined transceiver is implemented on a continuous piece of a semiconductor.

In one embodiment, the at least one narrowband and ultra wideband radio transceivers share a common crystal. This has the advantage of a more compact design, fewer pins and synchronization between the narrowband and ultra wideband radio transceivers.

In one embodiment, the at least one narrowband and ultra wideband radio transceivers operate from same voltage supply. This simplifies design and routing while making the design compact.

In one embodiment, the at least one narrowband transceiver is configured to use a BLE protocol and the at least one ultra wideband transceiver is scheduled in the time slots that are not used by the BLE protocol. This allows for efficient use of the available spectrum—as well as being able to accurately time NB and UWB transmissions. This can be used as part of a real time location system (RTLS).

In one embodiment, the at least one narrowband transceiver is configured to use an IEEE 802.15.4 protocol having SIFS/LIFS slots and the at least one ultra wideband transceiver is scheduled in the SIFS/LIFS slots. This allows for efficient use of the available spectrum.

In one embodiment, the at least one narrow band radio transceiver is configured to operate in at least one of the ISM bands 433, 868, 915 or 2400 MHz.

In one embodiment, the at least one ultra wideband transceiver is configured to use impulse type signalling.

In one embodiment, the at least one ultra wideband transceiver is configured to operate in the 4.5 to 12 GHz frequency range.

In one embodiment, the at least one narrowband and ultra wideband radio transceivers share a common digital control to arbitrate access to an antenna. This simplifies design while ensuring proper allocation of available resources.

In one embodiment, the monolithic combined transceiver further comprises means for operating the at least one narrow band and ultra wideband transceiver interleaved or in parallel depending on a chosen algorithm.

In one embodiment, the at least one narrowband and ultra wideband radio transceivers share a common antenna pin. This simplifies design and routing while making the design compact.

In one embodiment, the at least one narrow band radio transceiver is configured to transmit on a TX pin or another pin, while the ultra wideband radio transceiver is configured to receive on an opposite pin of the another pin or the TX pin.

In one embodiment, the at least one narrowband and ultra wideband radio transceivers are configured for a signal bandwidth ratio of equal to or more than 25 times.

In another aspect of the invention, a method for operating a monolithic combined transceiver is provided, wherein the monolithic combined transceiver comprises at least one narrowband transceiver, and at least one ultra wideband transceiver, wherein the method comprises time interleaving the operations of the at least one narrowband and ultra wideband radio transceivers.

In one embodiment, the narrowband transceiver is configured to use a BLE protocol, wherein the method comprises scheduling the at least one ultra wideband transceiver in the time slots that is not used by the BLE protocol.

In one embodiment, the narrowband transceiver is configured to use an IEEE 802.15.4 protocol having SIFS/LIFS slots, wherein the method comprises scheduling the at least one ultra wideband transceiver in the SIFS/LIFS slots.

In one embodiment, the method comprises operating the narrow band radio transceiver to transmit on a TX pin or another pin, while operating the at least one ultra wideband radio transceiver to receive on an opposite pin of the another pin or the TX pin.

In one embodiment, the at least one ultra wideband radio transceiver is scheduled directly after an at least one narrowband radio transceiver transmission, so that the narrowband and ultra wideband radio transceivers are thus seen as a receiver as one unit.

In one embodiment, a time between narrowband and ultra wideband radio transceivers are used as a measure to check drift of local time.

In one embodiment, the at least one narrowband and ultra wideband radio transceivers are scheduled according to a round robin approach or by priority by sharing RF antenna pins.

In one embodiment, the at least one ultra wideband radio transceiver signal is used for real time location system (RTLS), while within a time duration X one will listen to a BLE packet.

### Effects of the Invention

The present invention comprises a technological advantage over known systems and methods, by use of monolithic combined transceiver, in terms of simplicity, cost and space savings.

The present invention provides several further advantageous effects:
it makes it possible to share external components such as crystals, one or more power sources and antennae,
it makes it possible to reduce the pin count on packaging for such monolithic solutions,
it makes it possible to embed logic for coordination, interleaving and IO control of each transceiver,
it simplifies synergies between protocols used for each transceiver, such as interleave control and power control, using otherwise idle time slots,
it allows for very accurate timing when handling the two different transceivers, such as time of flight measurements of RF signals, and
the monolithic approach gives lower area overhead but also reduces energy consumption significantly.

### BRIEF DESCRIPTION OF THE DRAWINGS

The above and further features of the invention are set forth with reference to the appended claims and together with advantages thereof. These will become clearer in consideration of the following detailed description of an [exemplary] embodiment of the invention given with reference to the accompanying drawings.

The invention will be further described below in connection with exemplary embodiments which are schematically shown in the drawings, wherein:

FIG. 1 shows a typical embodiment of a system,

FIG. 2 shows a first communications diagram for communications between a tag and an anchor,

FIGS. 3A and 3B show typical timing diagrams with narrowband and ultra wideband radio transceiver operations,

FIG. 4 shows a second communications diagram for communications between a tag and an anchor.

### DESCRIPTION OF THE REFERENCE SIGNS

The following reference numbers and signs refer to the drawings:

| | |
|---|---|
| 100 | The system |
| 102 | Power supply |
| 104 | Antenna |
| 106 | Crystal |
| 110 | RF pins |
| 112 | TX pin |
| 114 | RX pins |
| 115 | Other pins |
| 122 | Anchor |
| 124 | Tag |
| 200 | The monolithic combined transceiver |
| 300 | Narrowband radio transceiver |
| 400 | Ultra wideband radio transceiver |
| 500 | Timing diagram |
| 502 | Narrowband radio transceiver idling |
| 504 | Narrowband radio transceiver transmission |
| 506 | Narrowband radio transceiver reception |
| 512 | Ultra wideband radio transceiver idling |
| 514 | Ultra wideband radio transceiver transmission |
| 516 | Ultra wideband radio transceiver reception |
| 520 | Timing |
| 522 | Timing delta T |
| 524 | Timing gamma |
| 526 | Timing delta T + gamma |
| 528 | X |
| 530 | Communication diagram |
| 531 | BLE starts RTLS |
| 532 | UWB burst with ID #X |
| 533 | BLE: Object type challenge to ID #X |
| 534 | BLE: Object type response from ID #X |
| 540 | Communications diagram for RTLS |
| 541 | Request ranging |
| 542 | Response ranging |
| 543 | Time now tag |
| 544 | Time now anchor - send at time T1 |
| 545 | UWB Ranging |
| 547 | Narrowband |
| 548 | Time of flight (TOF) |

### DETAILED DESCRIPTION OF THE INVENTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented, or a method may be practiced, using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The invention will be further described in connection with exemplary embodiments which are schematically shown in the drawings, wherein:

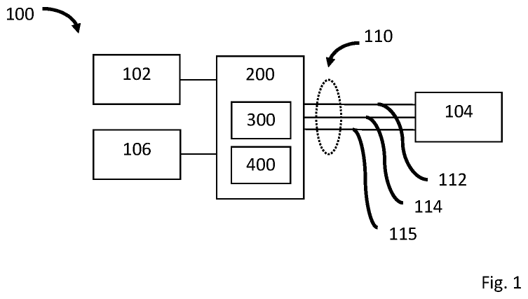

FIG. 1 shows a typical embodiment of a system 100 with a monolithic combined transceiver 200 operatively connected to power supply 102, an antenna 104, a crystal 106 for stable frequency control, and RF pins 110 that comprise TX pin 112, RX pin 114 and possibly other pins 115.

### Principles Forming the Basis of the Invention

With monolithic system on chip we define a continuous piece of silicon that implements all functionalities of the system. It is not a collection of multiple pieces of silicon that are bonded together or attached using any other appropriate connection mechanism.

With narrow band radio transceivers we define a radio transceiver that carries signals in a frequency band less than or equal to 20 MHz. The narrow band radio transceiver can define multiple of these bands/Channels.

With ultra wideband radio transceivers we define a radio transceiver that carries signals in a frequency band greater than or equal to 500 MHz.

The invention relates to a system on chip that implements both a narrow band and ultra wideband radio transceiver. The system preferably implements one or more CPUs, volatile and/or non-volatile memories, power management unit and other typical digital and analog peripherals common for system on chips known by those skilled in the art.

The narrow band radio can be used for data communication. The ultra wideband radio can be used for real time location tracking, as well as data communication.

The two radio transceivers can share a common digital control to arbitrate access to the antenna. This way complex scheduling scheme can be implemented where narrow band and ultra wideband radio traffic is interleaved or sent in parallel depending on the chosen algorithm. In the case of BLE it can be beneficial that the UWB traffic is scheduled in the time slots that are not used by the BLE protocol. Likewise, for IEEE 802.15.4 it can be beneficial that UWB signals are sent in the SIFS/LIFS slots—where there is no requirement for the radio to be in transmit or receive mode. This allows, for instance, for the narrow band and ultra wideband transceiver to share antenna pins.

The two radio transceivers can share one or more common blocks such as frequency reference—more commonly a crystal, power regulators, current and voltage sources, frequency multipliers and dividers, modulation blocks, base band processing blocks, analog and digital filters etc.

A typical system of the industry will today have the two radio transceivers implemented in different pieces of silicon. Thus, these will occupy a larger space on a printed circuit board, will have a high packaging overhead, and there will be no way of sharing of common components outlined above. A system where the transceivers are not monolithic will generally be more expensive.

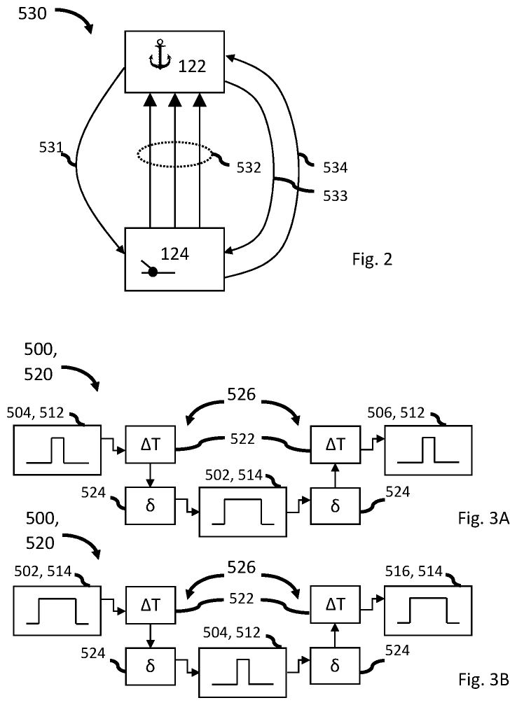

FIG. 2 shows a first communications diagram for communications between a tag and an anchor, wherein the protocol starts with the anchor 122 issuing a BLE transmission 531 to start the real time location system RTLS.
In the second step, the node 124 responds with a UWB burst 532 that comprises an identification (ID) number X (#X)
In the third step the anchor 122 responds by issuing a BLE transmission 533 with an object type challenge for ID #X.
In the fourth step the node 124 responds with a BLE transmission with object type response for ID #X.

One or both of the anchor and tag can be a system as shown in FIG. 1.

FIGS. 3A and 3B show a typical timing diagram with narrowband and ultra wideband radio transceiver operations. For synchronisation and handling time slots, several algorithms are envisaged.

FIG. 3A shows a first embodiment where the UWB is scheduled directly after an NB transmission. The NB+UWB is thus seen at the receiver as one unit. They are easily associated with one another due to timing. The time between receipt of the NB and UWB transmissions can also be used as a measure to check drift of local time. If this is set to always be deltaT, but is measured by the receiver node to be deltaT+gamma, the system can determine that local time has drifted.

FIG. 3B shows an alternative second embodiment where the NB is scheduled directly after the UWB transmission.

In another embodiment UWB and NB transmissions are scheduled according to a round robin approach or by priority because they share RF antenna pins.

In yet another embodiment UWB signal is used for RTLS, but within time duration X one will listen to a BLE packet. This way one can implement a system that has
a) RTLS but also
b) interrogating properties.

The system can thereby determine where an object is and also what it is.

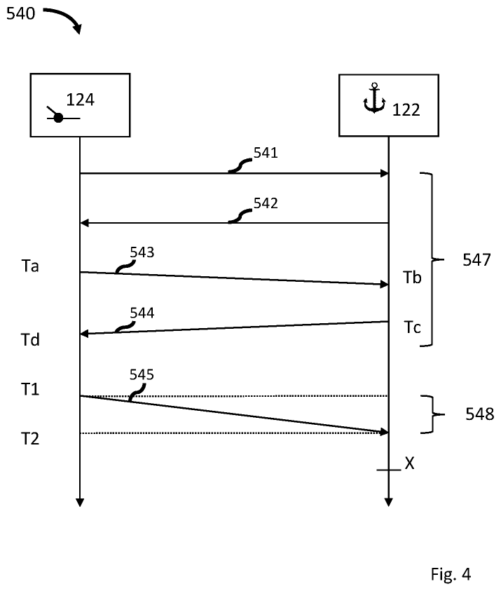

FIG. 4 shows a second communications diagram 540 for communications between a tag and an anchor, wherein the protocol starts with one or more NB transmissions, wherein the node 514 issues a request for ranging 541.
In the second step, the anchor 512 responds with a response to the ranging request 542.
In the third step, the tag 514 transmits a current time tag 543 at time Ta, which is received at the anchor at time Tb.
In the fourth step, the anchor 512 transmits a current time tag 544 at time Tc with a request to send at time T1. This is received at the tag at time Td.
In the fifth step, the system switches from NB mode to UWB, and the tag waits until time T1 and starts transmitting at time T1, which is received at the anchor at time T2.

### INDUSTRIAL APPLICABILITY

The invention according to the application finds use in communication and localisation systems.

1. A monolithic combined transceiver (200) comprising:
at least one narrowband transceiver (300), and
at least one ultra wideband transceiver (400),
wherein the monolithic combined transceiver (200) is implemented on a continuous piece of a semiconductor.

2. The monolithic combined transceiver (200) according to claim 1, wherein the at least one narrowband and ultra wideband radio transceivers (300, 400) share a common crystal.

3. The monolithic combined transceiver (200) according to claim 1, wherein the at least one narrowband and ultra wideband radio transceivers (300, 400) operate from the same voltage supply (102).

4. The monolithic combined transceiver (200) according to claim 1, wherein the at least one narrowband transceiver (300) is configured to use a BLE protocol and the at least one ultra wideband transceiver is scheduled in the time slots that are not used by the BLE protocol.

5. The monolithic combined transceiver (200) according to claim 1, wherein the at least one narrowband transceiver (300) is configured to use an IEEE 802.15.4 protocol having SIFS/LIFS slots and the at least one ultra wideband transceiver (400) is scheduled in the SIFS/LIFS slots.

6. The monolithic combined transceiver (200) according to claim 1, wherein the at least one narrow band radio transceiver (300) is configured to operate in at least one of the ISM bands 433, 868, 915 or 2400 MHz.

7. The monolithic combined transceiver (200) according to claim 1, wherein the at least one ultra wideband transceiver (400) is configured to use impulse type signalling.

8. The monolithic combined transceiver (200) according to claim 1, wherein the at least one ultra wideband transceiver (400) is configured to operate in the 4.5 to 12 GHz frequency range.

9. The monolithic combined transceiver (200) according to claim 1, wherein the at least one narrowband and ultra wideband radio transceivers (300, 400) share a common digital control to arbitrate access to an antenna.

10. The monolithic combined transceiver (200) according to claim 1, wherein the monolithic combined transceiver further comprises means for operating the at least one narrow band and ultra wideband transceiver (300, 400) in an interleaved or in parallel mode depending on a chosen algorithm.

11. The monolithic combined transceiver (200) according to claim 1, wherein the at least one narrowband and ultra wideband radio transceivers (300, 400) share a common antenna pin.

12. The monolithic combined transceiver (200) according to claim 1, wherein the at least one narrow band radio transceiver (300) is configured to transmit on a TX pin or another pin, while the at least one ultra wideband radio transceiver (400) is configured to receive on an opposite pin of the another pin or the TX pin.

13. The monolithic combined transceiver (200) according to claim 1, wherein the at least one narrowband and ultra wideband radio transceivers (300, 400) are configured for a signal bandwidth ratio of equal to or more than 25 times.

14. A method for operating a monolithic combined transceiver (200) comprising:
at least one narrowband transceiver (300), and
at least one ultra wideband transceiver (400),
wherein the method comprises time interleaving the operations of the at least one narrowband and ultra wideband radio transceivers (300, 400).

15. The method according to claim 14, wherein the narrowband transceiver (300) is configured to use a BLE protocol,
wherein the method comprises scheduling the at least one ultra wideband transceiver (400) in the time slots that are not used by the BLE protocol.

16. The method according to claim 14, wherein the at least one narrowband transceiver (300) is configured to use an IEEE 802.15.4 protocol having SIFS/LIFS slots,
wherein the method comprises scheduling the at least one ultra wideband transceiver (400) in the SIFS/LIFS slots.

17. The method according to claim 14, wherein the method comprises operating the at least one narrow band radio transceiver (300) to transmit on a TX pin or another pin
while operating the at least one ultra wideband radio transceiver (400) to receive on an opposite pin of the another pin or the TX pin.

18. The method according to claim 14, wherein the at least one ultra wideband radio transceiver is scheduled directly after an at least one narrowband radio transceiver (300) transmission, so that the narrowband and ultra wideband radio transceivers (300, 400) are thus seen as a receiver as one unit.

19. The method according to claim 18, wherein a time between narrowband and ultra wideband radio transceivers (300, 400) are used as a measure to check drift of local time.

20. The method according to claim 14, wherein the at least one narrowband and ultra wideband radio transceivers (300, 400) are scheduled round robin or by priority by sharing RF antenna pins.

21. The method according to claim 15, wherein the at least one ultra wideband radio transceiver signal is used for real time location system (RTLS), while within a time duration X one will listen to a BLE packet.
